(19) United States
(12) Patent Application Publication
(10) Pub. No.: US 2009/0092340 A1
(43) Pub. Date: Apr. 9, 2009

(54) NATURAL LANGUAGE ASSISTANCE FOR DIGITAL IMAGE INDEXING

(75) Inventor: Carlos Alejandro Arguelles, Shoreline, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/867,703

(22) Filed: Oct. 5, 2007

(51) Int. Cl. G06K 9/54

(52) U.S. Cl. 382/306

(57) ABSTRACT

A processing device and method may provide natural language assistance for digital image indexing. Candidate keywords may be generated based on an entered keyword for a digital image file. The candidate keywords may be synonyms of the entered keyword, or otherwise related to the entered keyword. The candidate keywords may be ranked as possible keywords for the digital image file based on use of the candidate keywords as keywords of other digital image files. Similarity measures of the other digital image files may be determined based on aspects of the other digital image files compared with the corresponding aspects of the digital image file. Rankings of the candidate keywords may be adjusted based on the similarity measures of the other digital image files. At least some of the ranked candidate keywords may be presented.

### BACKGROUND

Digital image files, such as, for example, photo files, may have embedded metadata. The metadata may not be visible when viewing a digital image, but may provide various items of information, such as, for example, type of camera used, focal length, aperture setting, shutter speed, as well as other items of information. In addition, a user may add one or more keywords to the metadata.

The one or more added keywords may describe aspects of the digital image and may make finding the digital image easier. This is especially true if the digital image is included in a large collection of digital images. For example, the user may add keywords, such as, for example, “beach”, “sunset”, “tropical”, and “ocean” to metadata of a digital image file of a digital image of a beautiful sunset on a beach. When searching for the digital image among thousands of digital images, the user may use one or more of the keywords to describe the digital image, resulting in the digital image being found.

A disadvantage of using one or more keywords to search for a desired digital image is that the user may find the desired digital image only if the user remembers the one or more keywords used to describe the desired digital image. For example, if the user added a keyword “sea” to describe the desired digital image, and later used a keyword “ocean” to search for the desired digital image, the search would be unsuccessful. Further, if the user added a misspelled keyword to describe a digital image, the digital image may never be found unless the user enters the misspelled keyword when searching for the digital image.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a processing device may provide natural language assistance for digital imaging indexing. Candidate keywords, with respect to a current digital image file, may be generated based on a received entered keyword. Respective ones of the candidate keywords may be ranked based on use of the respective ones of the candidate keywords as keywords of other digital image files. Ones of the candidate keywords that are more likely to be selected as keywords may have higher rankings than others of the candidate keywords less likely to be selected as keywords. In some embodiments, various aspects of the other digital image files may be compared with corresponding aspects of the current digital image file resulting in similarity measures being assigned to the other digital image files. Rankings of the respective ones of the candidate keywords may be adjusted based on the assigned similarity measures.

In some embodiments, a thesaurus application may be applied to the entered keyword to generate synonyms and/or other words related to the entered keyword. The generated synonyms and/or other words related to the entered keyword may be used to create candidate keywords.

The candidate keywords may be assigned confidence values reflecting a level of confidence that respective candidate keywords will be selected as keywords. Ones of the candidate keywords having a confidence value greater than a predetermined amount may be presented to a user. Upon selection of one of the one or more presented candidate keywords, the selected one of the one or more presented candidate keywords may be added as keywords for the current digital image file.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates a functional block diagram of a processing device, which may be used to implement embodiments consistent with the subject matter of this disclosure.

FIG. 2 illustrates an exemplary display screen, which may be presented by a processing device in embodiments consistent with the subject matter of this disclosure.

FIG. 3 illustrates an exemplary method, which may be implemented in embodiments consistent with the subject matter of this disclosure, for finding digital image files similar to a current digital image file.

FIG. 4 is a flowchart illustrating an exemplary process, which may be performed in embodiments consistent with the subject matter of this disclosure.

FIG. 5 is a flowchart illustrating an exemplary process for performing act 404 of FIG. 4 in embodiments consistent with the subject matter of this disclosure.

FIG. 6 is a flowchart illustrating an exemplary process for performing act 406 of FIG. 4 in embodiments consistent with the subject matter of this disclosure.

FIG. 7 is a flowchart illustrating an exemplary process for performing act 612 of FIG. 6 in embodiments consistent with the subject matter of this disclosure.

FIG. 8 is a flowchart illustrating an exemplary process for performing act 614 of FIG. 6 in embodiments consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a method and a processing device for providing natural language assistance for indexing digital images. In some embodiments, a user may provide, as input to a processing device, an entered keyword to be used as an index for a digital image file. One or more candidate keywords may be generated based on the entered keyword. The one or more candidate keywords may be synonyms of the entered keyword, or otherwise related to the entered keyword. The one or more candidate keywords may be ranked as a possible keyword for the digital image file based on use of the one or more candidate keywords as a keyword of similar digital images in digital image files. In some embodiments, rankings of the candidate keywords may be adjusted based on a similarity measure (to be described below) of other digital image files having a keyword matching the entered keyword and a keyword matching one of the one or more candidate keywords. Ones of the one or more candidate keywords having a confidence value greater than a predetermined amount may be presented to the user. The confidence value for a candidate keyword may be a value reflecting a level of confidence that the user will select the candidate keyword to be a keyword. Upon selection of one of the one or more candidate keywords, the selected one of the one or more candidate keywords may be added as a keyword for the digital image file.

### Exemplary Processing Device

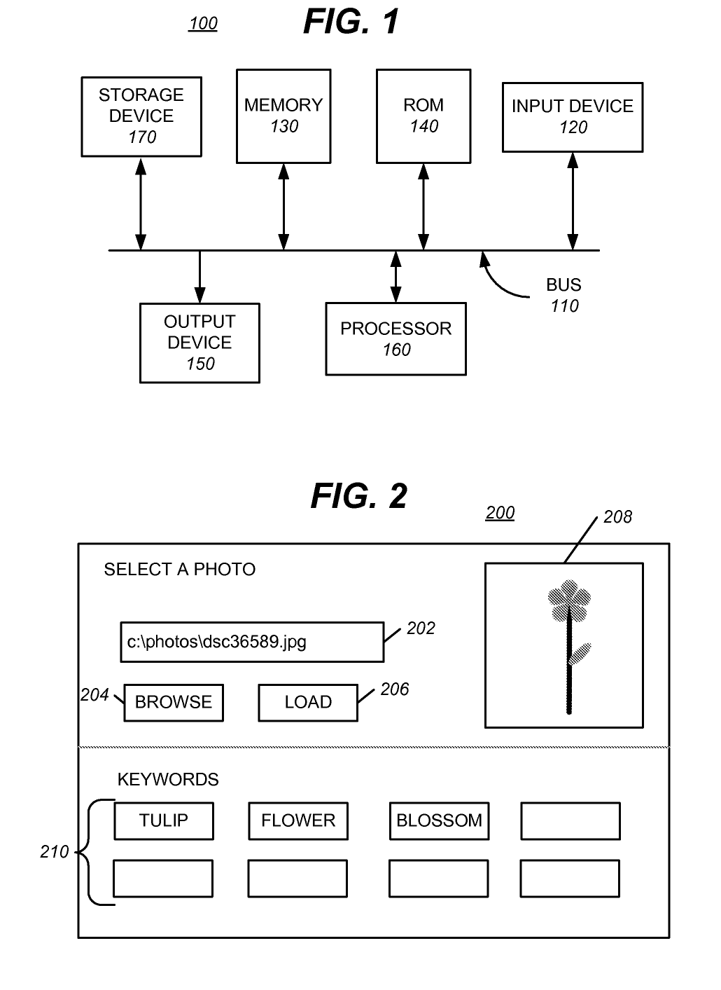

FIG. 1 is a functional block diagram of an exemplary processing device 100, which may be used in embodiments consistent with the subject matter of this disclosure. Processing device 100 may include a bus 110, an input device 120, a memory 130, a read only memory (ROM) 140, an output device 150, a processor 160, and a storage device 170. Bus 110 may permit communication among components of processing device 100.

Processor 160 may include at least one conventional processor or microprocessor that interprets and executes instructions. Memory 130 may be a random access memory (RAM) or another type of dynamic storage device that stores information and instructions for execution by processor 160. Memory 130 may also store temporary variables or other intermediate information used during execution of instructions by processor 160. ROM 140 may include a conventional ROM device or another type of static storage device that stores static information and instructions for processor 160. Storage device 170 may include a compact disc (CD), digital video disc (DVD), a magnetic medium, or other type of storage device for storing data and/or instructions for processor 160.

Input device 120 may include a keyboard, a joystick, a pointing device or other input device. Output device 150 may include one or more conventional mechanisms that output information, including one or more display screens, or other output devices.

Processing device 100 may perform such functions in response to processor 160 executing sequences of instructions contained in a tangible machine-readable medium, such as, for example, memory 130, ROM 140, storage device 170 or other medium. Such instructions may be read into memory 130 from another machine-readable medium or from a separate device via a communication interface (not shown).

### Exemplary Display

FIG. 2 illustrates an exemplary display 200 which may be displayed on a display screen of processing device 100 in embodiments consistent with the subject matter of this disclosure. A user may enter a filename, which may include a full pathname, into window 202. The filename may include a name of a digital image file including a digital image. Alternatively, the user may select a browse control 204 via a pointing device, a user's finger on a touchscreen, or via other methods. Upon selecting browse control 204, the user may be presented with a menu of folders and/or filenames. Upon selecting one of the folders, one or more subfolders and/or filenames may be displayed. When one of the filenames is selected, the filename, along with a complete pathname, may be displayed in window 202. The user may then select a load control 206 to cause a digital image 208, corresponding to the filename displayed in window 202, to be displayed. Display 200 may further display one or more keywords 210, which may be included in metadata of a digital image file including digital image 208. Exemplary display 200 shows keywords “tulip”, “flower”, and “blossom”, which may be included in the metadata of the digital image file.

### Exemplary Processing

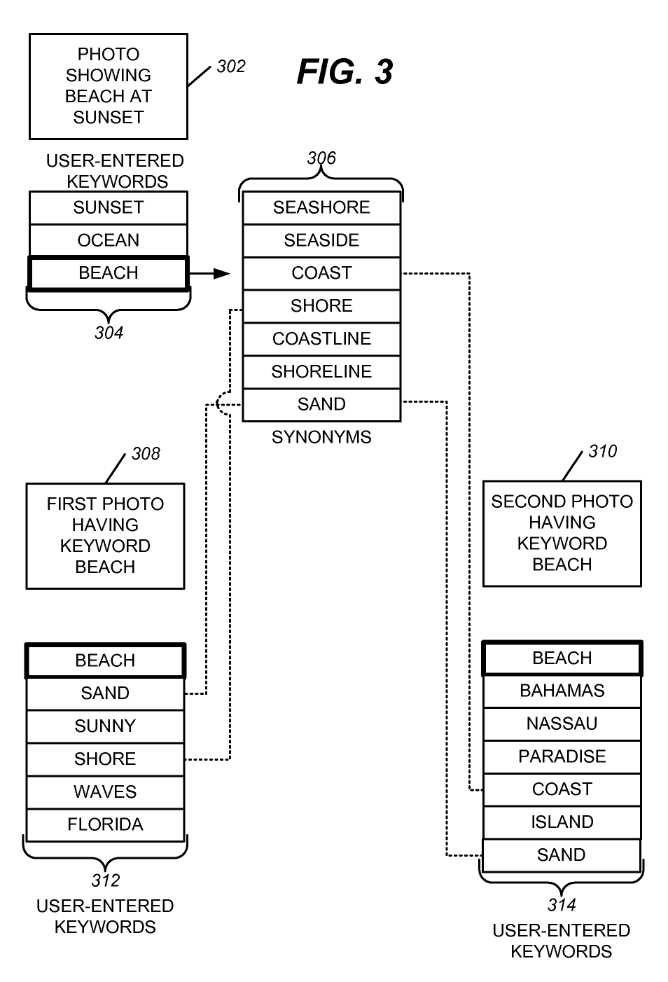

FIG. 3 illustrates an exemplary method, which may be implemented in a processing device, such as, for example, processing device 100, in embodiments consistent with the subject matter of this disclosure, for finding digital images similar to a current digital image. In FIG. 3, a current digital image may be digital image 302, which may be a photo showing a beach at sunset. A digital image file including digital image 302 may have metadata including user-entered keywords 304, such as, for example, “sunset”, and “ocean”. A user may enter a new keyword, such as, for example, “beach”, or, alternatively, may select a previously entered user keyword “beach” associated with digital image 302. As a result, a language tool, such as, for example, a thesaurus, or other language tool, may generate candidate keywords 306, which may be synonyms or other words related to entered keyword “beach”. In this example, candidate keywords 306 may include “seashore”, “seaside”, “coast”, “shore”, “coastline”, “shoreline”, and “sand”.

Next, processing device 100 may search for digital image files having metadata including a keyword matching the entered keyword “beach”. In this example, digital image files including a digital image 308 and a digital image 310 may be found including user-entered keywords 312 and 314, respectively, matching the entered keyword “beach”. Processing device 100 may then determine whether any user-entered keywords of digital image files having a keyword matching the entered keyword, also have a keyword matching any of candidate keywords 306. In this example, user entered keywords 312 of the digital image file including digital image 308 include user-entered keywords “sand” and “shore” matching corresponding words of candidate keywords 306. User-entered keywords 314 of the digital image file including digital image 310 include user-entered keywords “coast” and “sand” matching corresponding words of candidate keywords 306.

In one embodiment, each of candidate keywords 306 may be ranked based on a number of digital image files having metadata including the entered keyword and a keyword matching a respective one of candidate keywords 306. In the example of FIG. 3, candidate keyword “sand” may be ranked higher than candidate keyword “shore” because keyword “sand” is associated with two digital image files, while keyword “shore” is associated with only one digital image file.

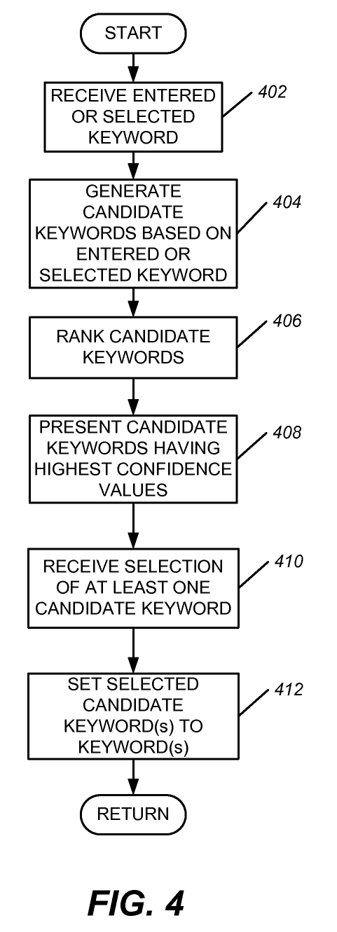

FIG. 4 is a flowchart illustrating an exemplary process, which may be performed in embodiments consistent with the subject matter of this disclosure. The process may begin with a processing device, such as, for example, processing device 100, receiving an entered keyword or a selection of a previously-entered keyword with respect to a current digital image file (act 402). Processing device 100 may then generate candidate keywords based on the entered or selected previously-entered keyword (act 404).

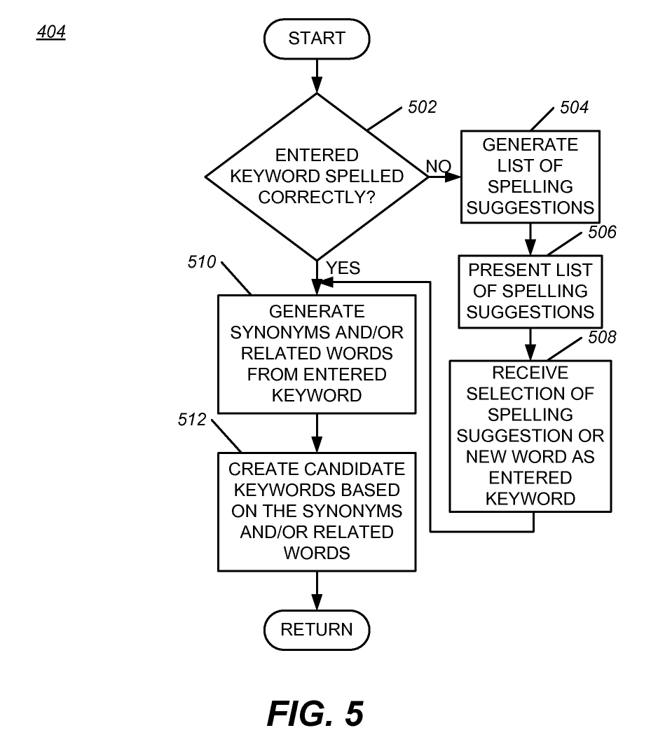

FIG. 5 is a flowchart illustrating an exemplary process for performing act 404 of FIG. 1. The process may begin with processing device 100 spellchecking the entered keyword to determine whether the entered keyword is spelled correctly (act 502). In one embodiment, processing device 100 may execute a spellchecking application to spell check the entered keyword. This may be performed by determining whether the entered keyword is included in a spelling dictionary.

If the entered keyword is not spelled correctly, then processing device 100 may generate a list of spelling suggestions (act 504). This may be achieved by finding words similar to the entered keyword in the spelling dictionary, such as, for example, words that differ form the entered keyword by one or two letters or words similar to the entered keyword, but with some letters transposed. Processing device 100 may then present the list of spelling suggestions (act 506). The list of spelling suggestions may be presented on a display screen of processing device 100. Processing device 100 may then receive a selection of one of the spelling suggestions or may receive a new word, which is to replace the entered keyword (act 508). The selected spelling suggestion may be selected by a user using a pointing device, such as, for example, a computer mouse or other pointing device, a stylus, a finger, or other object on a touchscreen of processing device 100, or via other input means.

If, during act 502, processing device 100 determines that the entered keyword is spelled correctly, then processing device 100 may generate synonyms and/or words related to the entered keyword (act 510). In one embodiment, processing device 100 may execute a thesaurus application to generate the synonyms and/or the words related to the entered keyword. Processing device 100 may then create candidate keywords based on the generated synonyms and/or words related to the entered keyword (act 512).

Returning to FIG. 4, processing device 100 may then rank the candidate keywords based on which of the candidate keywords are more likely to be selected by the user as a keyword for the current digital image file (act 406).

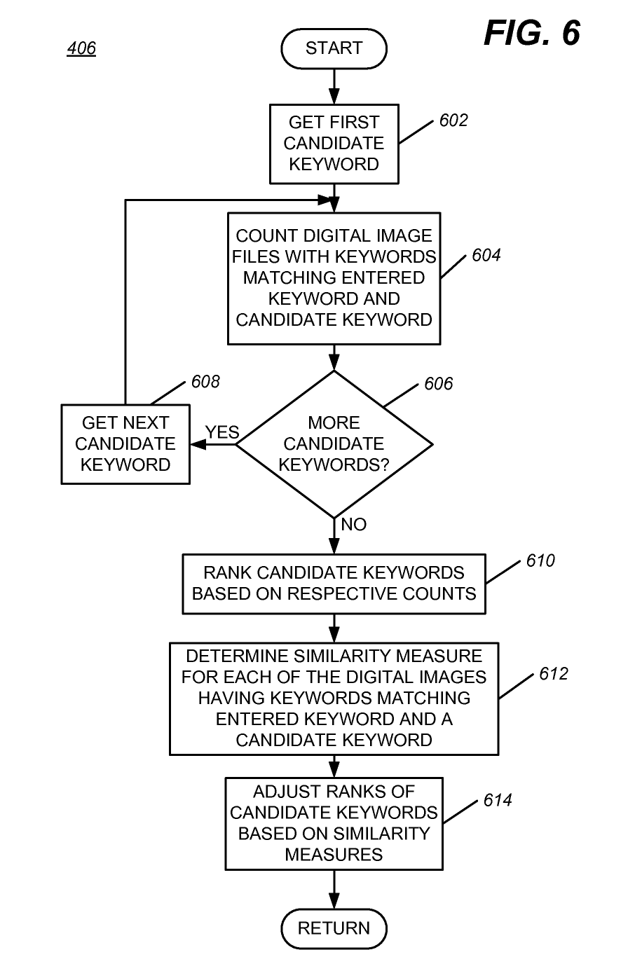

FIG. 6 illustrates a flowchart of an exemplary process for performing act 406 to rank the candidate keywords. The process may begin with processing device 100 getting a first candidate keyword (act 602). Processing device 100 may then count a number of digital image files having keywords matching the entered keyword and the candidate keyword (act 604). Processing device 100 may then determine whether there are additional candidate keywords with respect to the current digital image file (act 606). If there are additional candidate keywords with respect to the current digital image file, then processing device 100 may get a next candidate keyword (act 608) and may again perform acts 604-606.

If, during act 606, processing device 100 determines that there are no additional candidate keywords, then processing device 100 may rank the candidate keywords based on respective counts of digital image files having a keyword matching the entered keyword and a keyword matching a respective candidate keyword (act 610). The candidate keywords may be ranked such that a respective one of the candidate keywords not matching a keyword of a digital image file which also has a keyword matching the entered keyword, may be assigned a lowest rank. A respective one of the candidate keywords matching a keyword of only one digital image file, which also has a keyword matching the entered keyword, may be assigned a next lowest rank. A respective one of the candidate keywords matching a keyword of multiple digital image files, which have keywords matching the entered keyword, may be assigned a highest rank. Thus, the candidate keywords may be ranked based on a frequency of use of the candidate keywords as keywords in digital images, which have keywords matching the entered keyword. Other ranking schemes may be implemented in other embodiments.

Next, processing device 100 may determine a similarity measure for each of the digital image files having a keyword matching the entered keyword and a keyword matching a respective candidate keyword (act 612). In some embodiments, the similarity measure may be based on a similarity of a number of aspects of the current digital image file with digital image files having keywords matching the entered keyword and one of the candidate keywords. In some embodiments, a number of image diffing plugins may be used to compare the number of aspects of the current digital image file with the digital image files having keywords matching the entered keyword and one of the candidate keywords. Each one of the image diffing plugins may return a confidence value in a range of {0 . . . 1}, where a confidence value of 1 may indicate that a respective aspect of the current digital image file is 100% equal to a corresponding aspect of a respective one of the digital image files having keywords matching the entered keyword and one of the candidate keywords, and a confidence value of 0 may indicate that a respective aspect of the current digital image file is 0% equal to a corresponding aspect of a respective one of the digital image files having keywords matching the entered keyword and one of the candidate keywords.

In one embodiment consistent with the subject matter of this disclosure, the aspects may include time similarity, geographic location similarity, disk similarity, keyword similarity, accumulative similarities based on metadata included in digital image files, RGB brightness histogram similarity, edge similarity, and features similarity. In other embodiments, the aspects may include additional, fewer, or different aspects.

Time similarity of a digital image file may refer to a capture date field in metadata of the digital image file. If digital images were captured, or taken, within seconds of each other, the digital images are more likely to be images of a same thing. In one embodiment, digital images captured within 0 seconds of each other may have a confidence value of 1 with respect to time similarity. The confidence value may be fitted to a logarithmic curve that approaches 0 when the digital images are captured about eight hours apart.

Geographic location similarity may use GPS coordinates in metadata of the digital image file. If digital images were captured, or taken, within close proximity of one other, the digital images are more likely to be of a same thing. In one embodiment, the digital images captured within 0 distance of one another may have a confidence value of 1 with respect to geographic location similarity. The confidence value may be fitted to a logarithmic curve that approaches 0 when the GPS coordinates in the metadata of the digital image files indicate that the distance approaches at least about 60 miles.

Disk similarity may use an operating system path of digital image files to determine if the digital image files are located in a same folder, or a nearby folder. If the digital image files are included in a same folder, the confidence value may be 1 with respect to disk similarity. In one embodiment, if one of the digital image files is in a parent folder of another of the digital image files, then the confidence value may be 0.5.

With respect to keyword similarity, if two digital image files have more than one keyword in common, then they are more “similar”. If all keywords are in common, then the confidence value may be 1 with respect to keyword similarity. If there are no keywords in common, then the confidence value may be 0.

With respect to accumulative similarities found in metadata included in digital files, a confidence value may be based on the accumulative similarities in Exchangeable Image File (EXIF) metadata or International Press Telecommunications Council (IPTC) metadata found in digital image files. EXIF metadata may be included in nearly all digital image files and may be provided by a digital camera or other image capturing device. EXIF metadata may include, but not be limited to:
camera model and serial number (indicating whether images were captured by a same camera,
light available, which may be inferred indirectly from shutter speed, aperture and ISO (indicating whether images were captured in similar lighting conditions),
lens related information, such as, for example, (a) lens name (e.g. “EF16-35 mm f/2.8L USM”), (b) focal length (e.g. 16 mm), and (c) hyperfocal distance (e.g. 2.13 m) (indicating whether the pictures were taken with a same lens and composition), and
Orientation, such as, portrait or landscape.
   IPTC metadata may be voluntarily added to digital image files by a user of a digital camera or other image capturing device. IPTC metadata may include, but not be limited to, title, author, description, copyright information, and/or other information.

With respect to RGB brightness histogram similarity, matching RGB brightness of pixels of digital images of digital image files may indicate similarity of the digital images. A confidence value of 1, with respect to RGB brightness histogram similarity, may indicate that the digital images are identical.

With respect to edge similarity, and edge finding algorithm may be used to determine where edges are in digital images of digital image files. The edges may be diffed, or compared, to determine whether the digital images are of a same subject. If the edges are identical, then the confidence value may be 1 with respect to edge similarity. If the edges are completely different, then the confidence value may be 0.

With respect to feature similarity, a feature recognizer may be applied to determine a similarity between a feature in a first digital image of a first digital image file with a feature in a second digital image of a second digital image file. The feature may be any one of a number of things including, but not limited to a face, a house, and a car. The feature recognizer may output a list of found features and may provide information for each of the found features, such as, for example (a) type (face, car, etc.), and (b) location in a digital image.

The location in the image may be used to gauge a percentage of the image taken up by the feature. For example, if an image includes a feature which occupies 70% of a total image surface, then a similarity weight of the feature may be 0.7 out of a possible value from 0 to 1, inclusive. The similarity weight may be higher for a close-portrait of a person than an image of a person standing on a hill far away because the feature (for example, a face) in the close-portrait occupies more image surface than the feature of the image of a person standing on a hill.

With similarity weights of each of the features determined, individual traits of the features in a first image may be compared with individual traits of the features in a second image. When a type of a feature of the first image and the second image match, a small value may be added to the confidence value. For example, if a type of a feature of the first image and the second image is “face”, a small value may be added to the confidence value regardless of whether or not the faces match each other. Further, well-known feature-comparison algorithms may determine a level of similarity between two features. For example, if the feature is a face, one of the well-known feature comparison algorithms may determine that a face in one image is a 70% match of a face in another image. The level of similarity determined by one or more of the well-known feature comparison algorithms, or other comparison algorithms, may be taken into account when determining the confidence value with respect to feature similarity.

In some embodiments, performance of the diffing algorithms may be improved. For example, if a number of digital images to compare is greater than a predetermined number, such as, for example, 50 or another suitable value, then the digital images may be reduced to low resolution, such as, for example, thumbnail versions, before comparisons performed by the diffing algorithms.

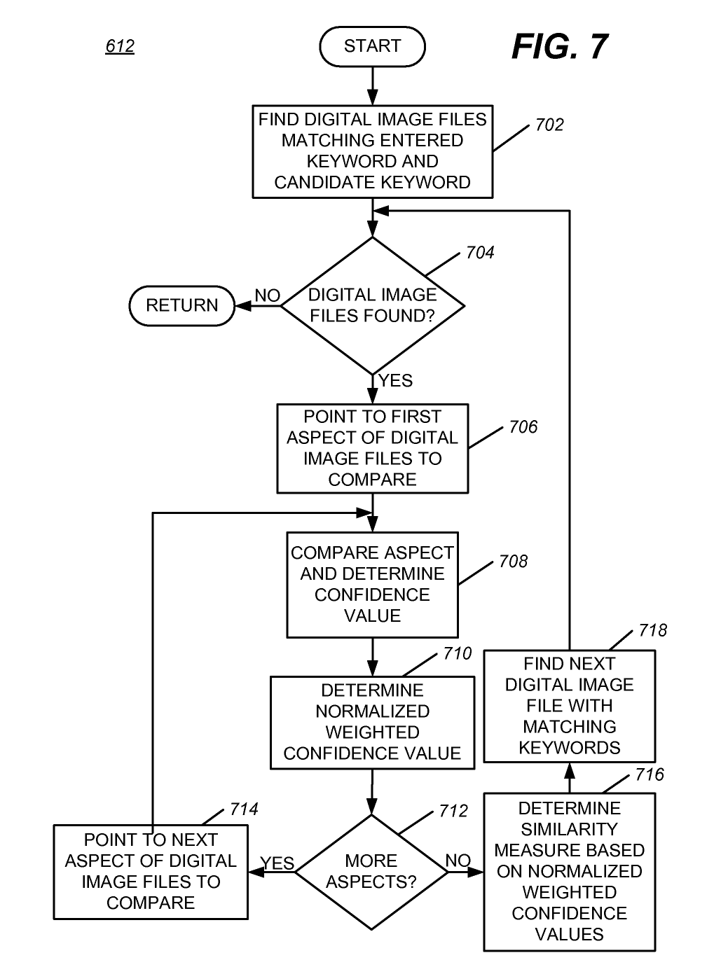

FIG. 7 is a flowchart illustrating an exemplary process for performing act 612. The process may begin with processing device 100 finding digital image files that have keywords matching the entered keyword and one of the candidate keywords (act 702). Processing device 100 may then determine whether any digital image files that match the entered keyword and one of the candidate keywords were found (act 704). If no digital image files were found, then the process may be completed. Otherwise, processing device 100 may prepare to compare aspects of digital image files by pointing to a first aspect to compare (act 706). In some embodiments, processing device 100 may prepare to compare the first aspect of the digital image files by preparing to execute a first image diffing plugin.

Processing device 100 may then compare the aspect of the digital image files with a corresponding aspect of the current digital image file and determine a confidence value with respect to the compared aspect (act 708). The aspect of the digital image files may include any of the aspects previously mentioned, or other aspects. In addition, as mentioned previously, the determined confidence value, in some embodiments, may be a value in a range of {0 . . . 1}.

In some embodiments, processing device 100 may determine a normalized weighted confidence value based on the determined confidence value (act 710). Weights applied to the confidence value may be user-configurable, such that a user may determine which of the aspects are more important than others of the aspects and may assign weights accordingly. Thus, for example, a user who decides that time similarity is more important than keyword similarity, many assign a higher weight to time similarity than to keyword similarity.

Processing device 100 may then determine whether there are more aspects of the digital image files to compare (acts 712). If there are more aspects of the digital image files to compare, then processing device 100 may prepare to compare a next aspect of the digital image files by pointing to a next aspect to compare (act 714). Processing device 100 may then repeat acts 708-712.

If processing device 100 determines that there are no additional aspects of the digital image files to compare, then processing device 100 may determine a similarity measure based on the normalized weighted confidence values of the compared aspects of the digital image files (act 716). Processing device 100 may determine the similarity measure by adding the normalized weighted confidence values of the compared aspects of the digital image files. The determined similarity measure may have a value in a range of {0 . . . 1}, where 1 indicates that the aspects of the compared digital image files are identical and 0 indicates that the aspects of the compared digital image files are completely different.

Processing device 100 may then find a next digital image file having keywords matching the entered keyword and a candidate keyboard (act 718). Processing device 100 may then repeat acts 704-718.

Returning to FIG. 6, after determining similarity measures with respect to each of the digital image files having keywords matching the entered keyword and one of the candidate keywords, processing device 100 may adjust rankings of the candidate keywords based on the determined similarity measures (act 614).

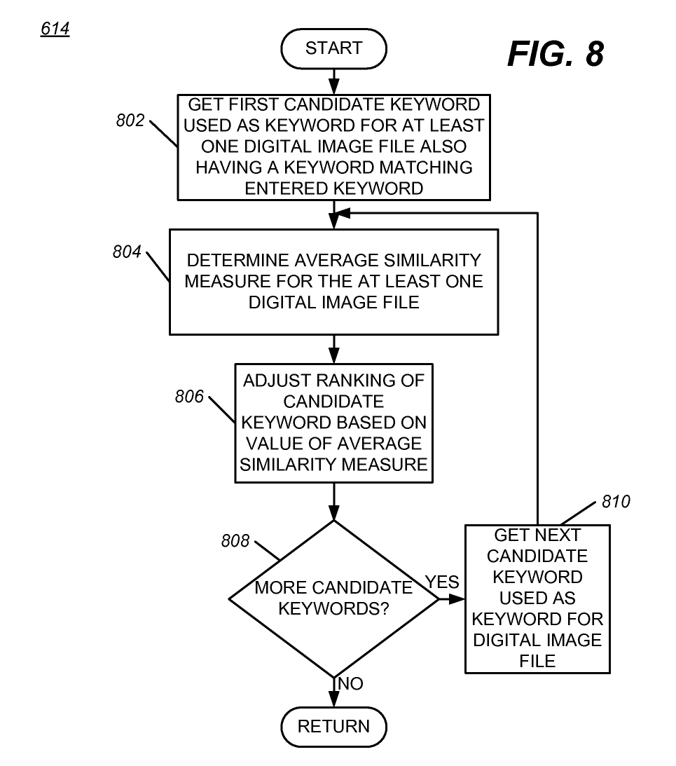

FIG. 8 is a flowchart of an exemplary process, which may be implemented in embodiments consistent with the subject matter of this disclosure, for performing act 614. The process may begin with processing device 100 getting a first candidate keyword, with respect to a current digital image file, that matches a keyword associated with at least one other digital image file that also has a keyword matching the entered keyword (act 802). Processing device 100 may then determine respective average similarity measures for at least one other digital image file with respect to the current digital image file (act 804).

Processing device 100 may then adjust a ranking of the candidate keyword with respect to the current digital image file based on a value of the average similarity measure (act 806). For example, a particular candidate keyword for the current digital image file may have its rank adjusted higher if an average similarity measure, with respect to the current digital image file, of digital image files having a keyword matching the particular candidate keyword and another keyword matching the entered keyword exceeds a predetermined value, such as, for example, 0.7 or another suitable value. Similarly, the particular candidate keyword for the current digital image file may have its rank adjusted lower if an average similarity measure, with respect to the current digital image file, of the digital image files having a keyword matching the particular candidate keyword and another keyword matching the entered keyword is less than a second predetermined value, such as, for example, 0.3 or another suitable value. Of course, other schemes for adjusting ranks of candidate keywords with respect to a digital image file may be employed in other embodiments consistent with the subject matter of this disclosure.

Processing device 100 may then determine whether there are any additional candidate keywords, with respect to the current digital image file, that match a keyword of at least one other digital image file that also has a keyword matching the entered keyword (act 808). If there are no additional candidate keywords that match keywords of at least one other digital image file, then processing device 100 may determine that the process is completed. Otherwise, processing device 100 may get a next candidate keyword used as a keyword for at least one other digital image file (act 810). Processing device 100 may then repeat acts 804-808.

Returning to FIG. 4, processing device 100 may present candidate keywords having highest confidence values (act 408). In one embodiment, the presented candidate keywords may have respective confidence values greater than a predetermined amount, such as, for example, 0.6 or another suitable value. In some embodiments, a hash table, which may be called a confidence hash table, may be built such that the candidate keywords may be used as keys. In response to receiving one of the candidate keywords, the confidence hash table may provide a confidence value with respect to the received one of the candidate keywords. The confidence values may reflect a level of confidence that particular candidate keywords will be selected as keywords for the current digital image file. The confidence values may be sorted by value, such that ones of the candidate keywords having higher confidence values may be presented before others of the candidate keywords having lower confidence values.

Processing device 100 may then receive a selection of at least one of the candidate keywords (act 410). For example, the user may select at least one of the candidate keywords by using a pointing device, a stylus or finger on a touchscreen, or via other input means. As a result of receiving the selection of the at least one of the candidate keywords, the selected at least one of the candidate keywords may be set to respective keywords of the current digital image file (act 412). The process may then be completed.

In one embodiment, the user may select at least one of the candidate keywords by selecting a checkbox next to the at least one of the candidate keywords, thereby causing a check to appear in the checkbox. The user may then select an “Add” button or control to add the selected at least one of the candidate keywords as one or more keywords.

### Miscellaneous

In some embodiments consistent with the subject matter of this disclosure, results of frequently-done comparisons may be saved in a cache in a database. Thus, the results of frequently-done comparisons, such as, for example, comparisons performed when ranking candidate keywords, may be retrieved from the cache, instead of being performed over and over again. If the cache grows too large, lower-occurring instances of the frequently-done comparisons may be purged from the cache. A size of the cache may be configurable in some embodiments.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents define the invention, rather than any specific examples given.

I claim as my invention:

1. A machine-implemented method for generating and ranking at least one candidate keyword as a possible keyword for a digital image file, the machine-implemented method comprising:
receiving an entered keyword to be used as an index for the digital image file;
generating candidate keywords based on the entered keyword; and
ranking respective ones of the candidate keywords based on use of the respective ones of the candidate keywords as keywords of other digital image files.

2. The machine-implemented method of claim 1, further comprising:
comparing aspects of the digital image file with corresponding aspects of the other digital image files; and
assigning similarity measures to the other digital image files based on a result of the comparing, wherein:
the ranking of respective ones of the candidate keywords is further based on the similarity measures assigned to the other digital image files.

3. The machine-implemented method of claim 1, wherein the generating of candidate keywords based on the entered keyword further comprises:
generating synonyms for the entered keyword, and creating the candidate keywords based on the generated synonyms.

4. The machine-implemented method of claim 1, further comprising:
comparing aspects of the digital image file with corresponding aspects of the other digital image files; and
assigning similarity measures to the other digital image files based on a result of the comparing, wherein:
the ranking of respective ones of the candidate keywords is further based on the similarity measures assigned to the other digital image files, and
each of the similarity measures is based on at least one confidence value of at least one of a plurality of aspects of the other digital image file comprising: time similarity of when a digital image is taken; geographic location similarity of where a digital image is taken; digital storage folder storing a digital image; matching of keywords; RGB brightness of pixels; edge similarity of a digital image; and feature similarity of a digital image.

5. The machine-implemented method of claim 1, further comprising:
comparing aspects of the digital image file with corresponding aspects of the other digital image files; and
assigning similarity measures to the other digital image files based on a result of the comparing, wherein:
the ranking of respective ones of the candidate keywords is further based on the similarity measures assigned to the other digital image files, and
each of the similarity measures is based on at least one confidence value of at least one of a plurality of aspects with respect to a digital image file, each of the plurality of aspects being assigned a user-configurable weight.

6. The machine-implemented method of claim 1, further comprising:
comparing a digital image of the digital image file with other digital images of the other digital image files, wherein:
when a number of the other digital images to compare is greater than a predetermined number, the digital image and the other digital images are reduced to low resolution before performing the comparing.

7. The machine-implemented method of claim 1, wherein the generating of candidate keywords based on the entered keyword further comprises:
spellchecking the entered keyword;
generating a list of spelling suggestions when the spellchecking fails to indicate that the entered keyword is correctly spelled; and
presenting the list of spelling suggestions.

8. A processing device comprising:
at least one processor; and
a memory connected to the at least one processor, the memory including instructions for the at least one processor, the instructions comprising:
instructions for generating candidate keywords for a digital image file based on an entered keyword,
instructions for ranking the candidate keywords based on a frequency of use of the candidate keywords as keywords of other digital image files, and
instructions for presenting at least some of the ranked candidate keywords.

9. The processing device of claim 8, wherein the instructions for the at least one processor further comprise:
instructions for determining a similarity of the digital image file with ones of the other digital image files having at least one keyword in common with the candidate keywords for the digital image file, and
instructions for adjusting a ranking of the candidate keywords based on the determined similarity.

10. The processing device of claim 8, wherein the instructions for the at least one processor further comprise:
instructions for determining a similarity of the digital image file with ones of the other digital image files having at least one keyword in common with the candidate keywords for the digital image file, and
instructions for adjusting a ranking of the candidate keywords based on the determined similarity, wherein:
the instructions for determining a similarity of the digital image file with the ones of the other digital image files having at least one keyword in common with the candidate keywords for the digital image file further comprise:
instructions for determining a number of the ones of the other digital image files having at least one keyword in common with the candidate keywords for the digital image,
instructions for reducing a resolution of a digital image of the digital image file and digital images of the ones of the other digital image files when the number of the ones of the digital image files is greater than a predetermined number, and
instructions for comparing the digital image of the digital image file with the reduced resolution and the digital images of the ones of the other digital image files with the reduced resolution.

11. The processing device of claim 8, wherein the instructions further comprise:
instructions for maintaining a cache including results of frequently-used comparisons.

12. The processing device of claim 8, wherein the instructions for ranking the candidate keywords based on a frequency of use of the candidate keywords as keywords of other digital image files further comprise:
instructions for building a confidence hash, the confidence hash including values reflecting a level of confidence that particular candidate keywords will be selected as keywords for the digital image file.

13. The processing device of claim 8, wherein the instructions for the at least one processor further comprise:
instructions for comparing a plurality of aspects of the digital image file with a corresponding plurality of aspects of the other digital image files, and
instructions for determining values corresponding to a similarity of respective ones of the plurality of aspects of the digital image file with corresponding ones of the plurality of aspects of the other digital image files, at least some of the determined values being assigned a user-configurable weight.

14. A tangible machine-readable medium having instructions for at least one processor recorded thereon, the instructions comprising:
instructions for generating a plurality of candidate keywords for a digital image file based on an entered keyword for the digital image file;
instructions for determining ones of a plurality of other digital image files having a keyword matching at least one of the plurality of candidate keywords; and
instructions for determining a confidence value for respective ones of the plurality of candidate keywords based on a number of the ones of the plurality of other digital image files having a keyword matching the respective ones of the plurality of candidate keywords.

15. The tangible machine-readable medium of claim 14, wherein the instructions further comprise:
instructions for determining similarities between aspects of the digital image file and each of the aspects of the ones of the plurality of the other digital image files having a keyword matching at least one of the plurality of candidate keywords; and
instructions for adjusting respective ones of the confidence values for the ones of the plurality of candidate keywords based on the determined similarities.

16. The tangible machine-readable medium of claim 14, wherein the instructions further comprise:
instructions for determining similarities between aspects of the digital image file and each of the aspects of the ones of the plurality of other digital image files having a keyword matching at least one of the plurality of candidate keywords; and
instructions for adjusting respective ones of the confidence values for the ones of the plurality of candidate keywords based on the determined similarities, wherein
each of the aspects has a user-configurable weight assigned thereto.

17. The tangible machine-readable medium of claim 14, wherein the instructions for generating a plurality of candidate keywords for a digital image file based on an entered keyword for the digital image file further comprise:
instructions for determining a plurality of synonyms for the entered keyword, and
instructions for generating the plurality of candidate keywords based on the determined plurality of synonyms.

18. The tangible machine-readable medium of claim 14, wherein the instructions for generating a plurality of candidate keywords for a digital image file based on an entered keyword for the selected digital image further comprise:
instructions for determining whether the entered keyword is correctly spelled,
instructions for presenting a list of spelling suggestions when the entered keyword is determined not to be spelled correctly,
instructions for receiving a selection of one spelling suggestion from the presented list of spelling suggestions, and
instructions for generating at least one of the plurality of candidate keywords from the received selection of the one spelling suggestion.

19. The tangible machine-readable medium of claim 14, wherein the instructions further comprise:
instructions for adjusting the confidence value for the respective ones of the plurality of candidate keywords based on metadata included in the digital image file and the plurality of other digital image files.

20. The tangible machine-readable medium of claim 14, wherein the instructions further comprise:
instructions for presenting ones of the plurality of candidate keywords having a respective confidence value greater than a predetermined amount.
